(19) United States
(12) Patent Application Publication
(10) Pub. No.: US 2009/0073112 A1
(43) Pub. Date: Mar. 19, 2009

(54) METHOD AND SYSTEM FOR DYNAMICALLY CONFIGURABLE TACTILE FEEDBACK FOR NAVIGATIONAL SUPPORT

(75) Inventors: Sara H. Basson, White Plains, NY (US); Dimitri Kanevsky, Ossining, NY (US); Edward E. Kelley, Wappingers Falls, NY (US); Frances W. West, W. Newton, MA (US)

Correspondence Address: Cantor Colburn LLP - IBM Endicott, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/855,480

(22) Filed: Sep. 14, 2007

(51) Int. Cl. G09G 5/00

(52) U.S. Cl. 345/156

(57) ABSTRACT

A method for providing dynamically configurable tactile indicator signals on a control surface for navigational support, includes: detecting at least one of an operator's hands positioned on a control surface; routing control signals to a series of tactile sensors in proximity to the detected positions of at least one of the operator's hands; wherein the control signals actuate tactile feedback devices; wherein the control signals are based on navigational information; providing tactile feedback to the operator via the actuated tactile feedback devices; wherein the tactile feedback is dynamically configured in response to the number of operator hands detected on the control surface; and wherein the tactile feedback is dynamically configured in response to the position of at least one of the operators hands on the control surface.

### BACKGROUND OF THE INVENTION

1. Field of the Invention

This invention relates generally to navigational support, and more particularly to a method and system for providing dynamically configurable tactile indicator signals on control surfaces based on navigational parameters and commands.

2. Description of the Related Art

Global positioning system (GPS) devices have become popular navigational tools for automobiles, and other types of transportation. The Global Positioning System (GPS) is a satellite-based navigation system made up of a network of 24 satellites placed into orbit by the United States Department of Defense that provides signal information to GPS receivers. A GPS receiver utilizes the satellite signals to triangulate the GPS receiver's position. A GPS device utilizes the positional information to provide a user with location information in the context of map overlays, and navigational instruction. The navigational instruction and information is provided to the user visually on a display screen, supplemented by verbal queues. Examples of navigational information includes, the need to turn right or left, the presence of a fork in the road that can be ignored or that must be observed, the need to make a U-turn and do a course correction, and the distance remaining before a turn or route change will occur.

### SUMMARY OF THE INVENTION

Embodiments of the present invention include a method and system for providing dynamically configurable tactile indicator signals on a control surface for navigational support, the method includes: detecting at least one of an operator's hands positioned on a control surface; routing control signals to a series of tactile sensors in proximity to the detected positions of at least one of the operator's hands; wherein the control signals actuate tactile feedback devices; wherein the control signals are based on navigational information; providing tactile feedback to the operator via the actuated tactile feedback devices; wherein the tactile feedback is dynamically configured in response to the number of operator hands detected on the control surface; and wherein the tactile feedback is dynamically configured in response to the position of at least one of the operators hands on the control surface

A system for providing dynamically configurable tactile indicator signals for navigational support, the system includes: a control surface including a series of sensors and tactile feedback devices embedded therein; a central processing unit (CPU) in electrical signal communication with a GPS device and the control surface; wherein the CPU is configured with software to: detect at least one of an operator's hands positioned on the control surface; route control signals to the series of tactile feedback devices in proximity to the detected positions of at least one of the operator's hands; wherein the control signals actuate the tactile feedback devices that provide tactile feedback to the operator; wherein the control signals are based on navigational information derived from the GPS device; wherein the tactile feedback is dynamically configured in response to the number of operator hands detected on the control surface; and wherein the tactile feedback is dynamically configured in response to the position of at least one of the operators hands on the control surface.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for a method and system for providing dynamically configurable tactile indicator signals on control surfaces based on navigational parameters and commands.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a dynamically configurable tactile information system (TIS) configured for a vehicle steering wheel according to embodiments of the invention.

FIG. 2 is an operational block diagram of a touch sensor according to an embodiment of the invention.

FIG. 3A is a detailed representation of the mapping of fingers to tactile sensors of the TIS of FIG. 1 according to an embodiment of the invention.

FIG. 3B is a detailed operational diagram of activated tactile sensors of FIG. 3 providing patterns and warnings according to an embodiment of the invention.

FIG. 4 is a flow diagram illustrating dynamic mapping of a warning signal to tactile sensors positioned under a driver or operator's fingers according to embodiments of the invention.

The detailed description explains the preferred embodiments of the invention, together with advantages and features, by way of example with reference to the drawings.

### DETAILED DESCRIPTION

Embodiments of the invention provide a method and system for providing dynamically configurable tactile indicator signals on control surfaces based on navigational parameters and commands. Control surfaces may include, for example, vehicle steering wheels, airplane control yokes, maritime controls, motorcycle and bicycle handlebars. Handheld navigational devices, for example, for the sight impaired, may also incorporate embodiments of the invention. In addition, embodiments of the invention may also be implemented in seat pads, operator shoes, or in operator wristbands and ankle bands worn on both arms and legs, respectively.

The dynamically configurable tactile indicator signals, of embodiments of the invention, overcome the current multitude of visual indicators that may distract a driver or operator. In addition, tactile signals are advantageous in situations where audible signals are inaudible, or for individuals who have a hearing impairment.

Embodiments of the invention provide tactile feedback to impart navigational information. In a vehicle setting, the tactile information may be imparted through the control surfaces of a steering wheel apparatus. For example, directional commands such as the need to turn right or left may result in vibration or other tactile stimulation, on the right or left side, respectively, of the steering wheel to mark the direction that the driver needs to turn, or in a respective right or left wrist or ankle band. In addition, the proximity of the turn may be represented by the intensity of the vibration or other tactile stimuli. Additional mnemonic stimuli may be used to indicate the need for a U-turn.

Embodiments of the invention detect an operator's hand positions on a control surface, for example a steering wheel, with a series of sensors. The sensors indicate the position and number of the operator's hands on the control surface. If only one hand is detected, the tactile signals are adapted to only that hand. For example, when a driver's left and right hand positions are detected, signals are sent to a series of tactile devices, such as vibrators, that are operable coupled to a GPS device, closest to the drivers left or right hand position to indicate an upcoming turn or other required maneuver. Embodiments of the invention detect not only the hand, but also individual digits or fingers (thumb, index finger, middle finger, ring finger, and pinky) by utilizing biometric recognition, specific and unique for each finger. The biometrics may be based on visual appearance, or by fingerprints. If a driver or operator moves fingers or hands to other parts of a control surface, the tactile sensors will be dynamically activated in different parts of the control surface where the driver moved their fingers or hands.

The identification of precise location of individual digits on a control surface facilitates unique tactile signals to be sent to each digit, where the unique signal or their pattern provides different tactile information. Therefore, an operator or driver is provided with multiple sources of unique information without being required to take their hands off the control surface or their eyes off the road or navigational field.

In embodiments of the invention, the signals are sent to the fingers independent of their position on the wheel. Embodiments of the invention employ dynamic movement as well as static information, as one of the tactile signal sources. If the tactile signal moves rapidly from one finger to the next, for example, this may signal something that is rapidly approaching. In an additional example, if a tactile sensor is activated under one kind of finger—the required maneuver is imminent or a specified danger is high and requires immediate attention and reaction by the operator, while if a tactile sensor is activated under another kind of finger—this means just attention.

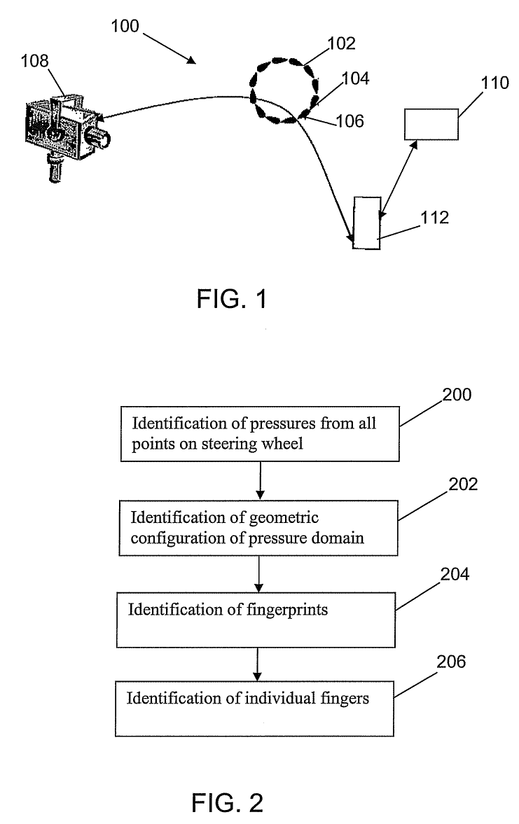

FIG. 1 illustrates a dynamically configurable tactile information system (TIS) 100 configured for operation with a vehicle steering wheel 102 as a control surface according to an embodiment of the invention. The TIS 100 consists of touch sensors 104, tactile sensors 106, camera 108 and a GPS 110 electrically connected to a controlling central processing unit (CPU) 112. The TIS 100 is configured for communication between the driver and the GPS 110 via tactile stimulation. Touch based systems have been previously described in U.S. Patent Publication 2006/0047386 entitled “Touch Gesture Based Interface for Motor Vehicle” and is hereby incorporated by reference herein.

Tactile sensors 106 in the form of vibration pads are located in the steering wheel 102. The vibration pads indicate to the driver important directions, calculated by the GPS 110, to bring the driver to a desired location. The driver, according to individual preference, configures the vibration stimuli. An example of the configuration is as follows: a vibration in the left vibration pad of the steering wheel 102 will indicate a left turn. A vibration in the right vibration pad of the steering wheel 102 will indicate a right turn. A U-turn will be indicated by vibration in both vibration pads. The touch sensors 104 in the steering wheel 102 indicate the position of the driver's hands and how many hands the driver has on the steering wheel, as well as the position of their fingers. The camera 108 provides visual information that also identifies the individual fingers and their placement on the steering wheel 102. The location of the vibration is adjusted according to the position of the driver's hands. If the driver does not have both hands on the steering wheel, navigation directions are indicated by the pattern of vibration to the individual fingers of the hand that is placed on the steering wheel 102. Specific navigational directions may also be indicated by the intensity or pattern of vibration. For example, the proximity of a turn may be indicated by the intensity or pattern of vibration.

The touch sensors 104 detect which finger is located in which position. Detection methods may include fingerprint data, and identification based on geometric patterns of fingers, whereby when the position of one distal finger is determined, the positional identities of the other fingers may be derived. In addition, the camera 108 provides visual information to identify individual fingers and finger placement. FIG. 2 is an operational block diagram of a touch sensor 104 on the steering wheel 102 according to an embodiment of the invention. The pressure points are identified on the steering wheel 102 (block 200), and converted to a geometric configuration in the pressure domain (block 202). Fingerprints are identified (block 204) and individual fingers are identified (block 206).

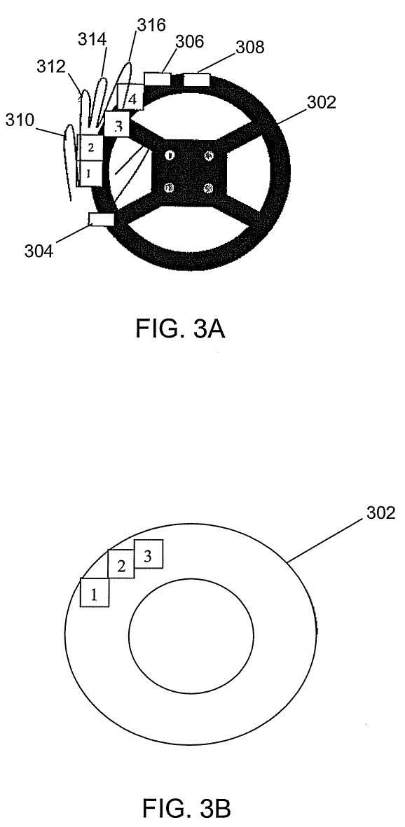

FIG. 3 is a detailed representation of the mapping of fingers to tactile sensors of the TIS of FIG. 1 according to an embodiment of the invention. In the example, steering wheel 302 has touch sensor locations in areas 304, 306, and 308. When a driver places their fingers (310, 312, 314, 316) on the steering wheel 302, vibrators identified by numbers 1, 2, 3, and 4 are activated to correspond with the placement of fingers (310, 312, 314, 316), respectively. Each of the vibrators (1, 2, 3, 4) provide individual tactile information to each of the fingers (310, 312, 314, 316), respectively.

FIG. 3B is a detailed operational diagram of activated tactile sensors of FIG. 3A providing patterns and warnings according to an embodiment of the invention. In this example, fingers 310, 312, 314 of the operator's left hand are placed on the steering wheel 302. Therefore, tactile sensors 1, 2, and 3 are activated. Examples of different dynamic modes of transmitting tactile information include sweeping the vibratory signal from tactile sensors 1 to 3 to indicate a right turn, or conversely sweeping the vibratory signals from tactile sensors 3 to 1 to indicate a left turn. If tactile sensors 1 to 3 are all active at once a u-turn may be required or a danger condition may be in progress.

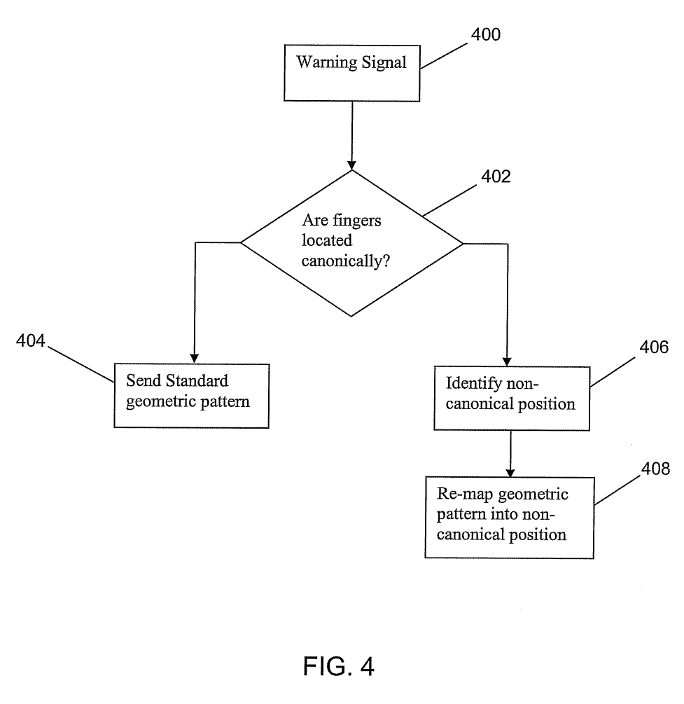

FIG. 4 is a flow diagram illustrating dynamic mapping of a warning signal to tactile sensors positioned under a driver or operator's fingers according to embodiments of the invention. A warning signal is received (block 400) and a determination is made if the driver or operator's fingers are located on the control surface in a standard defined position (are fingers located canonically?). If the fingers are located canonically (decision block 402 is Yes), a standard geometric tactile pattern for the canonical position is sent (block 404). If the fingers are not located canonically (decision block 402 is No), an identification of the operator's fingers in their non-conical state is made (block 406), and a re-mapping of tactile geometric pattern into the non-canonical position (block 408).

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for providing dynamically configurable tactile indicator signals on a control surface for navigational support, the method comprising:
detecting at least one of an operator's hands positioned on a control surface;
routing control signals to a series of tactile sensors in proximity to the detected positions of at least one of the operator's hands;
wherein the control signals actuate tactile feedback devices;
wherein the control signals are based on navigational information;
providing tactile feedback to the operator via the actuated tactile feedback devices;
wherein the tactile feedback is dynamically configured in response to the number of operator hands detected on the control surface; and
wherein the tactile feedback is dynamically configured in response to the position of at least one of the operators hands on the control surface.

2. The method of claim 1, wherein the detection of at least one of the operator hands is based on a series of sensors within the control surface.

3. The method of claim 1, wherein the control surface comprises at least one of the following: steering wheels, airplane control yokes, maritime controls, motorcycle handlebars, and bicycle handlebars.

4. The method of claim 1, wherein the tactile feedback is vibratory.

5. The method of claim 4, wherein the pattern of vibration imparts the navigational information to the operator.

6. The method of claim 4, wherein the intensity of vibration imparts the navigational information.

7. The method of claim 1, wherein the navigational information is derived from global positioning systems (GPS) devices.

8. The method of claim 1, wherein detecting at least one of an operator's hands positioned on a control surface further comprises:
determining the number and placement of the operator's fingers on the control surface.

9. The method of claim 8, wherein the determining of the number and placement of the operator's fingers includes the use of: fingerprint data, and geometric patterns of fingers, whereby when the position of one distal finger is determined the positions of the other fingers are derived.

10. The method of claim 8, wherein the determining of the number and placement of the operator's fingers includes observational inputs from one or more cameras.

11. The method of claim 8, wherein the tactile feedback is dynamically configured in response to the position of at least one or more of the operator's fingers on the control surface.

12. A system for providing dynamically configurable tactile indicator signals for navigational support, the system comprising:
a control surface including a series of sensors and tactile feedback devices embedded therein;
a central processing unit (CPU) in electrical signal communication with a GPS device and the control surface;
wherein the CPU is configured with software to:
detect at least one of an operator's hands positioned on the control surface;
route control signals to the series of tactile feedback devices in proximity to the detected positions of at least one of the operator's hands;
wherein the control signals actuate the tactile feedback devices that provide tactile feedback to the operator;
wherein the control signals are based on navigational information derived from the GPS device;
wherein the tactile feedback is dynamically configured in response to the number of operator hands detected on the control surface; and
wherein the tactile feedback is dynamically configured in response to the position of at least one of the operators hands on the control surface.

13. The system of claim 12, wherein the detection of at least one of the operator hands is based on the series of sensors within the control surface.

14. The system of claim 12, wherein the control surface comprises at least one of the following: steering wheels, airplane control yokes, maritime controls, motorcycle handlebars, and bicycle handlebars.

15. The system of claim 12, wherein the tactile feedback is vibratory.

16. The system of claim 15, wherein the pattern and intensity of vibration imparts the navigational information to the operator.

17. The system of claim 12, wherein the detection of at least one of an operator's hands positioned on the control surface further comprises:
the determination of the number and placement of the operator's fingers on the control surface.

18. The system of claim 17, wherein the determination of the number and placement of the operator's fingers includes the use of: fingerprint data, and geometric patterns of fingers, whereby when the position of one distal finger is determined the positions of the other fingers are derived.

19. The system of claim 17, wherein the determination of the number and placement of the operator's fingers includes observational inputs from one or more cameras.

20. The system of claim 17, wherein the tactile feedback is dynamically configured in response to the position of at least one or more of the operator's fingers on the control surface.
